(19) United States
(12) Patent Application Publication
(10) Pub. No.: US 2013/0339024 A1
(43) Pub. Date: Dec. 19, 2013

(54) PARKING LOT SYSTEM

(71) Applicant: Seiko Epson Corporation, Tokyo (JP)

(72) Inventor: Toshihiro KOJIMA, Suwa-shi (JP)

(21) Appl. No.: 13/915,139

(22) Filed: Jun. 11, 2013

(30) Foreign Application Priority Data
Jun. 19, 2012 (JP) 2012-137552
Apr. 25, 2013 (JP) 2013-092062

(51) Int. Cl. G08G 1/123

(52) U.S. Cl. CPC G08G 1/123
USPC 704/270.1

(57) ABSTRACT

A parking lot system includes a camera that photographs an image including a number plate of a vehicle, and generates a first image; an image analysis section that performs a number analysis processing to analyze the first image and acquire number information described on the number plate of the vehicle; a storage section that stores the number information and parked position information of the vehicle associated with one another; a speech acquisition section to acquire the voice of the user; a speech recognition section that performs a speech recognition processing on the voice; and an output section that performs an output processing to retrieve the number information from the storage section based on the result of the speech recognition processing and notifies the user of the parked position information.

The entire disclosures of Japan Patent Application No. 2012-137552, filed Jun. 19, 2012 and No. 2013-92062, filed Apr. 25, 2013 are expressly incorporated by reference herein.

### BACKGROUND

1. Technical Field

Several aspects of the present invention relates to parking lot systems.

2. Related Art

Apparatuses that use human voice are used in various areas. For example, such apparatuses include a device that notifies by voice general passers-by of danger when they approach a road work site and the like, a device for guiding about works of art exhibited in an art museum and the like. Further, JP-A-2006-318230 proposes a device that guides a driver to a vacant parking space in a parking lot by voice guidance that is conveyed on a supersonic wave so as to be heard only by the driver. Moreover, although voice is not used, JP-A-2009-098068 describes a system that reads a sign indicating a parked position with a camera that is connected to a car navigation system mount on a car, and transmits the sign to a cellular phone. In recent years, though the speech recognition technology that recognizes specific words based on human voice has been developed, and ideas for controlling various apparatuses have been proposed, there are still many areas where these technologies are not fully utilized.

As stated above, there are still many areas where these technologies are not fully utilized. For example, in large scale systems, such as, a parking lot system, its convenience has not been necessarily improved enough by using the speech recognition technology.

### SUMMARY OF THE INVENTION

The invention has been made to solve at least one of the problems or issues described above, and can be realized by various application examples and embodiments to be described below.

A parking lot system according to an aspect of an application example of the invention includes a camera that photographs an image including a number plate of a vehicle, and generates a first image, an image analysis section that performs a number analysis processing to analyze the first image and acquire number information described on the number plate of the vehicle, a storage section that stores the number information and parked position information of the vehicle associated with one another, a speech acquisition section to acquire the voice of the user, a speech recognition section that performs a speech recognition processing on the voice, and an output section that performs an output processing to retrieve the number information from the storage section based on the result of the speech recognition processing and notifies the user of the parked position information.

In the parking lot system according to an aspect of the application example, the camera may preferably photograph a plurality of the images with different periods of exposure time, and composite the plurality of the images to generate the first image.

The parking lot system according to an aspect of the application example may preferably include a display section, and the output processing may be a processing to display the parked position information at the display section.

In the parking lot system according to an aspect of the application example, the parking lot may preferably have a plurality of divided blocks where the vehicle can be parked, the parked position information may preferably indicate one of the divided blocks where the vehicle is parked, and the camera may be installed at each of the divided blocks.

In the parking lot system according to an aspect of the application example, each of the divided blocks is provided with a sensor, and the camera may preferably generate the first image upon detection by the sensor of parking of the vehicle.

The parking lot system according to an aspect of the application example may preferably further include a judgment section, the storage section may preferably store predetermined registration number information, and the judgment section may preferably compare the predetermined number information with the number information.

In the parking lot system according to an aspect of the application example, the predetermined register number may preferably be stored in the storage section through a network.

In the parking lot system according to an aspect of the application example, the judgment section may preferably communicate through the network when the number information coincides with the predetermined registration number.

In the parking lot system according to an aspect of the application example, a signal of the voice may preferably be stored in the storage section, when the speech recognition processing judges that the voice coincides with the predetermined registration number.

### Application Example 1

A parking lot system according to an application example 1, in a system for managing a parking lot, includes a camera that photographs an image including a number plate of a vehicle, an image analysis section that performs a number analysis processing to analyze the image and acquire number information, a storage section that stores the number information and parked position information of the vehicle associated with one another, a speech acquisition section to acquire the voice of the user, a speech recognition section that performs a speech recognition processing on the voice, and an output section that performs an output processing to retrieve the number information from the storage section based on the result of the speech recognition processing and notifies the user of the parked position information.

According to the composition described above, an image of a number plate of a vehicle is photographed by the camera, the image is analyzed and number information is acquired by the image analysis section, the number information and parked position information of the vehicle are stored in the storage section, and the user is notified of the vehicle parked position information based on the result of speech recognition on the voice of the user. Accordingly, a parking lot system by which the user can readily find the parked location of the vehicle can be composed.

For instance, when the user parks the car in a parking lot in a place the user is visiting, it often happens that the user parks not in a specific place but in an arbitrary empty parking space. In many parking lots, signs that indicate respective parking spaces may be displayed. However, the users may forget the sign of their parked position or do not even try to remember it in the first place. However, the users relatively well remember the number of the number plate of their own car. According to the present application example, the user can find the parked position information only by saying the number (at least one of the numbers or codes) of the number plate. Also, a parking lot system that can perform lot exiting processing and fee accounting processing at the lot exit can be implemented. Therefore, a parking lot system with improved convenience can be realized.

### Application Example 2

In the parking lot system according to the application example described above, the camera may preferably photograph a plurality of images with different periods of exposure time, and the image analysis section may preferably perform the number analysis processing based on at least one of the plurality of images.

According to the composition described above, the camera photographs a plurality of images with different periods of exposure time, and the number analysis processing is performed based on at least one of the plurality of images. Therefore, a reliable number analysis processing can be performed regardless of the period of time or the weather at the time of photographing.

The exposure time may be set to one of three different settings of exposure time suitable for daytime, night and evening in a sunny day, respectively. As a result, it can be judged that images photographed in each of the periods of exposure time include at least one image in which the number of the number plate is readable. Further, even in the daytime in bad weather, the exposure time for evening in a sunny day can be used. Therefore, photographing of images, which enables the number analysis processing regardless of the weather, can be performed.

### Application Example 3

In the parking lot system according to the application example described above, the image analysis section may preferably perform the number analysis processing based on a composite image composited from a plurality of images.

According to the composition described above, the number analysis processing is performed based on a composite image composited from a plurality of images photographed with different periods of exposure time. Therefore, the number analysis processing can be performed with the same processing regardless of the brightness of parked positions. Note that the camera itself may be provided with the function of compositing multiple images that are photographed with different periods of exposure time.

### Application Example 4

The parking lot system according to the application example described above may preferably further include a display section, and the output processing may be a processing to display the parked position information at the display section.

According to the composition described above, the user can be notified of the parked position information in a manner that can be readily recognized. The parked position information may be displayed by a sign that indicates the parked position, or may be presented by means of map information of the parking lot.

### Application Example 5

The parking lot system according to the application example described above may preferably further include a judgment section, the storage section may preferably store predetermined registration number information, and the judgment section may preferably compare the predetermined registration number information with the number information.

According to the composition described above, because the judgment section compares the predetermined registration number information stored in the storage section with the number information given as a result of the number analysis processing, a parking lot system that is capable of notifying as to whether a vehicle with a registered number is parked can be composed.

Number information to be registered as the predetermined registration number information may be number information of a stolen vehicle, or number information of a vehicle for which a parking reservation has been made. As a result, a parking lot system that is useful for finding stolen vehicles can be provided. Furthermore, as the parking lot system notifies the user of a parked position of a vehicle in response to the voice of the user, it is possible to acquire the voice of the user when the number of the vehicle concurs with the number of a stolen vehicle, whereby a parking lot system that is capable of assisting criminal investigation can be composed. Also, when a gate is provided at the exit of a parking lot, a parking lot system that locks the gate at the lot exit when the number information of a stolen vehicle is matched can be provided.

### BRIEF DESCRIPTION OF THE DRAWINGS

FIG. 1 is a function block diagram of a parking lot system in accordance with an embodiment of the invention.

FIG. 2 is a function block diagram of an example of the configuration of a parking lot system in accordance with an embodiment of the invention.

FIG. 3 is a diagram for explaining an example of the operation of a parking lot system in accordance with an embodiment of the invention.

FIG. 4 is a flow chart for explaining an example of the operation of the parking lot system when a car newly enters a parking lot.

FIG. 5 is an illustration of an example of a number plate.

FIG. 6 is a table of an example of the structure of data to be stored in a storage section.

FIG. 7 is a flow chart for explaining an example of the operation of the parking lot system when a vehicle exits a parking lot.

### DESCRIPTION OF EXEMPLARY EMBODIMENTS

Preferred embodiments of the invention are described in detail below with reference to the accompanying drawings. The drawings to be used are provided for the convenience of description. It is noted that the embodiments described below would not limit the content of the invention recited in the scope of the patent claims. Furthermore, all of the components to be described below may not necessarily be indispensable for the invention.

### First Embodiment

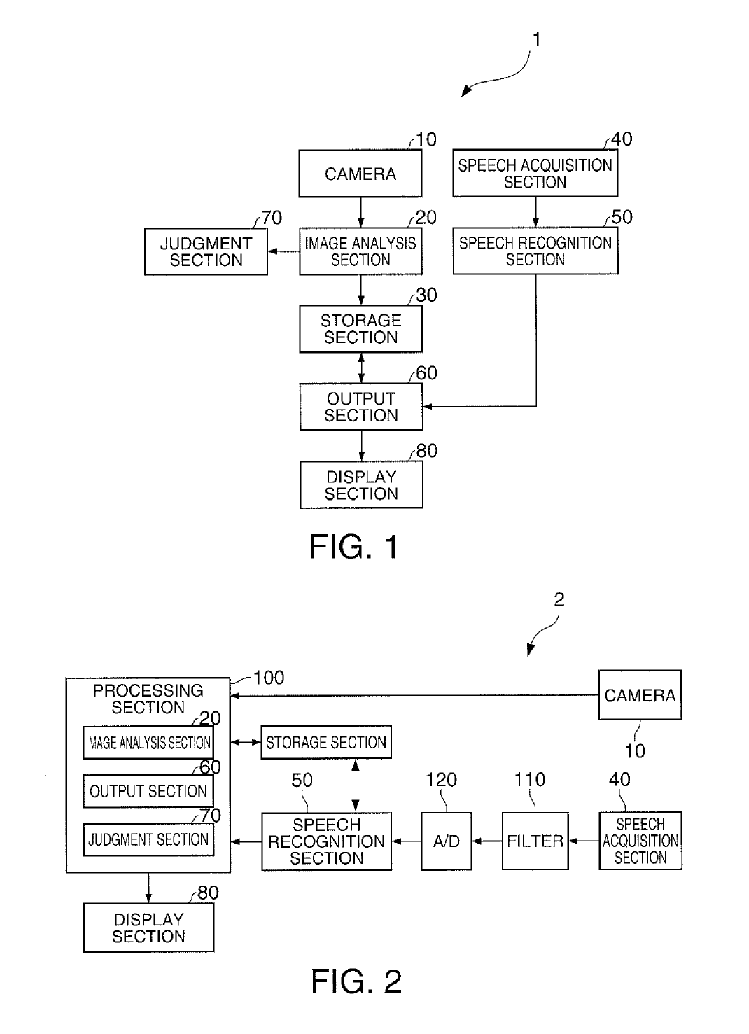

FIG. 1 is a function block diagram of a parking lot system 1 in accordance with an embodiment of the invention.

The parking lot system 1 is composed with a camera 10, an image analysis section 20, a storage section 30, a speech acquisition section 40, a speech recognition section 50 and an output section 60.

The camera 10 photographs an image including a number plate of a vehicle or the like. In the present embodiment, the camera 10 is composed with an imaging sensor, and outputs an image including a number plate as digital data. FIG. 1 shows only one camera 10, but multiple cameras 10 may be used. Also, the camera 10 may be appended with an identification sign associated with each parking position.

The image analysis section 20 is a number analysis processing unit that analyses an image photographed by the camera 10, and acquires number information on the number plate. Various known imaging analysis technologies are applicable as the image analysis section 20.

The storage section 30 associates the number information acquired in the number analysis processing and parked position information, and stores the information. In the present embodiment, the storage section 30 stores the number information acquired in the number analysis processing and the identification sign corresponding to the parked position given to the camera 10 that photographs an image serving as the base of the number analysis processing, associated with one another. Any one of various types of known storage devices can be used as the storage section 30.

The speech acquisition section 40 mainly acquires the voice that is uttered by the user. Any one of various types of known microphones can be used as the speech acquisition section 40.

The speech recognition section 50 processes the speech recognition on the voice acquired by the speech acquisition section 40. Any one of various known methods may be used as the method for speech recognition processing. For example, Hidden Markov model may be used to perform the speech recognition processing.

The output section 60 retrieves number information from the memory section 30 based on the result of the speech recognition processing by the speech recognition section 50, and performs an output processing that outputs parked position information corresponding to the retrieved number information. In other words, the output section 60 outputs the parked position information corresponding to the number information included in the voice that is uttered by the user.

In many cases, the user of a vehicle may remember the number of the number plate of the vehicle, but may not accurately remember the parked position. According to the parking lot system 1 of the present embodiment, when the user merely says the number of the number plate, the parked position is indicated, and parking lot exit processing and parking fee accounting processing can be performed. Therefore, the parking lot system 1 with improved convenience can be realized.

The camera 10 may photographs plural images with different periods of exposure time, and the image analysis section 20 may perform the number analysis processing based on at least one of the plural images photographed by the camera 10.

In particular, in an outdoor parking lot, because the brightness at a parked position may greatly change with the lapse of time. Therefore, an image that is photographed with one fixed exposure time may have blown out highlight or blocked up shadow, thereby making the number analysis processing difficult. However, by photographing plural images with different periods of exposure time, it is possible to photograph at least one image that enables the number analysis. Therefore, because the number analysis processing is performed based on at least one of the plural images with different periods of exposure time, the number analysis processing can be more reliably performed than the case where the number analysis processing is performed based on an image photographed with one fixed exposure time.

The image analysis section 20 may perform the number analysis processing based on a composite image composited from plural images photographed by the camera 10. The plural images may be composited by the camera 10, or by the image analysis section 20. By compositing plural images with different periods of exposure time into one image, the single image is given a wider exposure range, such that the number analysis processing by the image analysis section 20 can be done only on the single image, regardless of the brightness at the parking position.

For identifying vehicles parked in a parking lot, because the number of vehicles that can be parked in a parking lot is limited, parked vehicles can often be identified only by analyzing number parts of the number plates. Therefore, the speech recognition processing by the speech recognition section 50 can be set to focus on the recognition processing of the numbers. As a result, the efficiency of the processing by the speech recognition section 50 can be improved and its power saving can be achieved.

The judgment section 70 performs a judgment processing that compares registration number information pre-stored with the number information acquired in the number analysis processing, and judges whether they match. The registration numbers may be downloaded from a predetermined server by accessing the server through a network and stored in the storage section 30, or may be stored in the storage section 30 by an input device not shown in the figure.

As mentioned above, when the number information acquired in the number analysis processing corresponds to the registration number information, various measures become possible by using the parking lot system 1.

The display section 80 displays the number information and the parked position information based on at least one of the result of the speech recognition processing and the result of the output processing. By displaying the number information, the user can be notified of the result of the speech recognition processing; and when the result of the speech recognition processing is wrong, the user can be urged again to utter the number. Note that any one of various types of known display devices, such as, a liquid crystal panel, a CRT display or the like can be adopted as the display section 80.

According to the parking lot system 1 of the present embodiment, number information and parked position information can be displayed, such that the parking lot system 1 can be achieved with improved convenience for the users.

### Embodiment Example 1

FIG. 2 is a summary block diagram of the composition of a parking lot system 2 in accordance with an embodiment of the invention. Note that function blocks having functions similar to those of the function blocks described above are appended with the same names and the same reference numbers, and their description is omitted.

The parking lot system 2 is composed with a camera 10, a storage section 30, a speech acquisition section 40, a speech recognition section 50, a display section 80, a processing section 100, a filter 110, and an A/D converter 120.

In the parking lot system 2, the image analysis section 20, the output section 60, and the judgment section 70 are composed as parts of the processing section 100. The processing section 100 may be achieved by, for example, a CPU (Central Processing Unit) and a program executed by the CPU.

Note that the image analysis section 20, the speech recognition section 50, the output section 60, and the judgment section 70 may be achieved by using a dedicated electronic circuit.

A voice signal outputted from the speech acquisition section 40 is inputted through the filter 110 and the A/D converter 120 to the speech recognition section 50. Note that the filter 110 may be, for example, a low-pass filter.

As a result of the speech recognition processing, the speech recognition section 50 outputs number information to the processing section 100.

In the processing section 100, the image analysis section 20 performs the number analysis processing based on the image photographed by the camera 10. Moreover, the processing section 100 associates the number information acquired and the parked position information, based on the result of the number analysis processing, and stores them in the storage section 30. Further, the output section 60 in the processing section 100 performs the output processing based on the result of the speech recognition processing described above.

Also, the judgment section 70 may inquire a reservation number through a communication interface and a telecommunication line not shown in the figure. Any one of various types of known wired links or wireless links can be adopted as the telecommunication line.

Also, the processing section 100 displays the number information obtained as a result of the speech recognition processing and the parked position information associated with the number information in the display section 80.

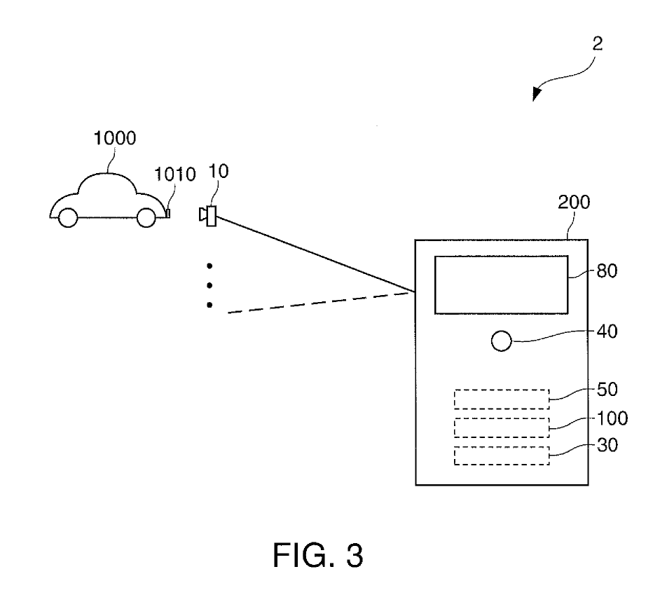

FIG. 3 is a diagram for explaining an example of the operation of the parking lot system 2. The components shown in FIG. 2 except the camera 10 are provided inside or on the surface of a housing 200. Also, multiple cameras 10 are installed at parking positions, respectively. Further, a vehicle 1000 is parked in a predetermined parked position, and the vehicle 1000 carries a number plate 1010.

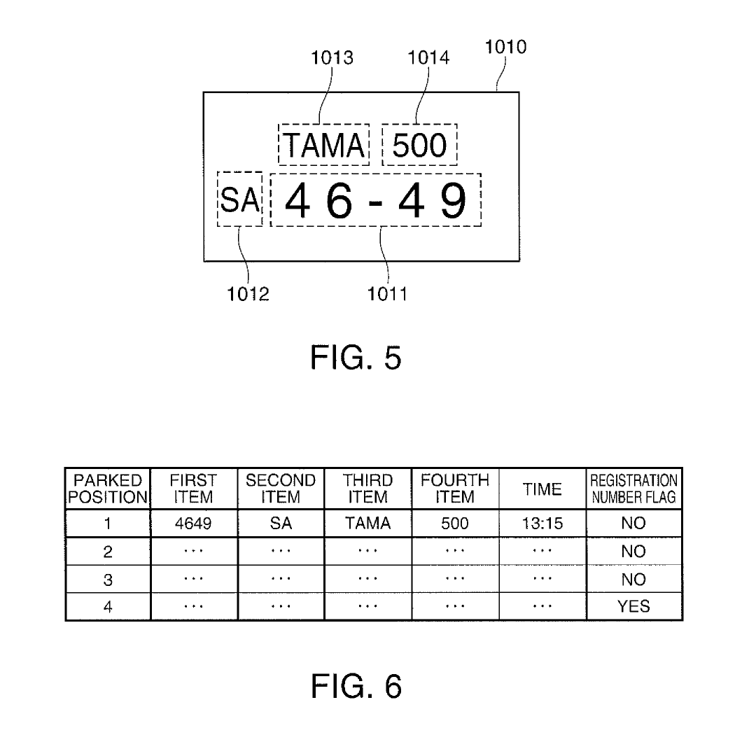

The camera 10 at the predetermined parking position photographs the number plate 1010 installed on the vehicle 1000. Note that an identification sign corresponding to the parking position is given to the camera 10, and this identification sign is used as parked position information. An example of the number plate 1010 is shown in FIG. 5.

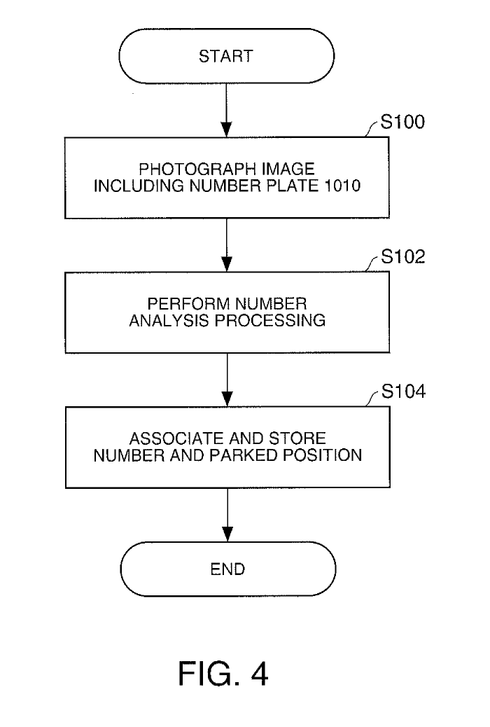

FIG. 4 is a flow chart for explaining an example of the operation of the parking lot system 2 when the vehicle 1000 newly enters a parking lot. It is assumed that the camera 10 detects the vehicle 1000 entering the parking lot by a sensor or the like.

First, the camera 10 photographs images including the number plate 1010 (step S100). In the present embodiment, the camera 10 photographs plural images with different periods of exposure time.

Next, the image analysis section 20 performs the number analysis processing to analyze the images photographed by the camera 10, and acquire number information of the number plate 1010 (step S102). In the embodiment, the number analysis processing is performed based on a composite image that is composited from the plural images photographed by the camera 10 with different periods of exposure time.

In the example shown in FIG. 5, the number information on the number plate 1010 is composed of a first item 1011, a second item 1012, a third item 1413, and a fourth item 1014. In the example shown in FIG. 5, the first item 1011 includes a character string of “46-49,” the second item 1012 includes a character string of “SA,” the third item 1013 includes a character string of “TAMA” and the fourth item 1014 includes a character string of “500.”

The image analysis section 20 extracts the first item 1011, the second item 1012, the third item 1013 and the fourth item 1014 from the composite image in the number analysis processing.

After step S102, the number information and the parked position information acquired in step S102 are associated and stored in the storage section 30 (step S104).

FIG. 6 is a table of an example of the structure of data to be stored in the storage section 30.

In the example shown in FIG. 6, the first item 1011, the second item 1012, the third item 1013 and the fourth item 1014 are associated with the parked position, and stored in the storage section 30. Also, in the example shown in FIG. 6, the time when the camera 10 photographed the image including the number plate 1010 is associated with the parked position, and stored in the storage section 30. Moreover, the judgment result with respect to the registration number given by the judgment section 70 is shown by “YES” or “NO”, associated with the parked position, and stored as a registration number flag.

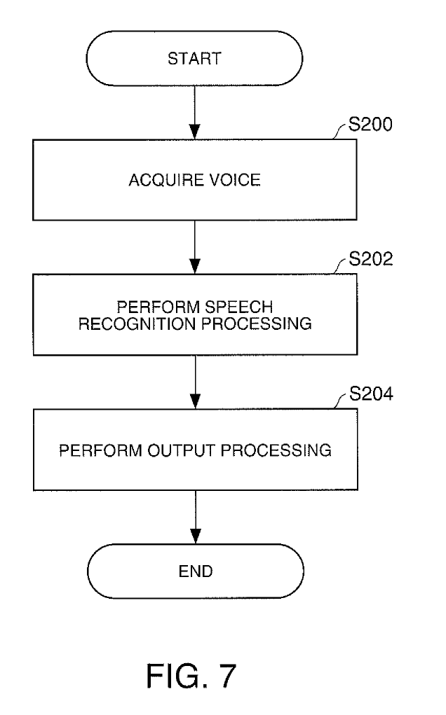

FIG. 7 is a flow chart for explaining an example of the operation of the parking lot system 2 when the vehicle 1000 exits the parking lot.

First, the speech acquisition section 40 acquires the voice uttered by the user (step S200). At this time, to make the user to speak, the processing section 100 may display a message to urge the user to make an utterance, etc. in the display section 80. In the following description, an example in which the user mainly utters the first item 1011 will be described.

After step S200, the speech recognition section 50 performs the speech recognition processing (step S202). For instance, when the user utters “four, six, four, nine,” the speech recognition section 50 sequentially outputs information for “4” “6” “4” “9” to the output section 60 in the processing section 100, as a result of the speech recognition processing.

After step S202, the output section 60 performs the output processing described above (step S204). For example, when the output section 60 sequentially receives the information for “4” “6” “4” “9” from the speech recognition section 50, the output section 60 retrieves data where the item 1011 is “4649” from the data stored in the storage section 30. Next, the output section 60 outputs “1” that indicates the parked position in the data where the item 1011 is “4649.”

When information on the next number is not received from the speech recognition section 50 within a predetermined period of time, the output part 60 may perform the output processing based on the information on the numbers that have already been received. As a result, for example, even when the item 1011 does not come up to four digits, the output processing can be appropriately performed.

When the parked position cannot be specified by the first item 1011 alone, the output section 60 may urge the user to utter the second item 1012. In this case, for example, the output section 60 may display a message or the like to urge an utterance of the second item 1012 in the display section 80.

The parking lot system 2 can perform various types processing based on the result of the processing by the output section 60. For example, the processing section 100 may display the parked position in the display section 80 by using a block plan of the parking space. Moreover, for example, when a car stop lock is provided in the parked position, the car stop lock may be released. Moreover, for example, the fee accounting processing for the parking fee may be performed based on the time when the camera 10 photographs an image including the number plate 1010.

In this manner, by the parking lot system 2 in accordance with the present embodiment, by only uttering the number of the number plate 1010 by the user, it is possible to perform processing according to the parked position. Therefore, the parking lot system 2 with improved convenience can be achieved.

The judgment section 70 may acquire number information on stolen vehicles from the data base of numbers of stolen vehicles through a communication line and store them in the storage section 30, compares the number information obtained as the result of the number analysis processing and the number information of the stolen vehicles stored in the storage section 30, and judges as to whether they correspond to each other. When they are judged to correspond to each other, the judgment section 70 changes the registration number flag in the storage section 30 from “NO” to “YES”.

The parking lot system 2 can perform various types of processing based on the result of the judgment processing by the judgment section 70. For example, when number information acquired in the number analysis processing corresponds to number information of a stolen vehicle, a processing to inform the authority may be performed. Also, for example, when number information acquired in the number analysis processing corresponds to number information on a stolen vehicle, a processing to prevent the car stop lock from being released may be performed. In this manner, the parking lot system 2 that is useful for finding stolen vehicles can be achieved.

### Second Embodiment

In the description of the present embodiment, description of components similar to those described in the first embodiment will be omitted.

A parking lot system according to the present embodiment pertains to a system for managing a parking lot, and includes a camera that photographs an image including a number plate of a vehicle, and generates a first image, an image analysis section that performs a number analysis processing to analyze the first image and acquire number information described on the number plate of the vehicle, a storage section that stores the number information and parked position information of the vehicle associated with one another, a speech acquisition section to acquire the voice of the user, a speech recognition section that performs a speech recognition processing on the voice, and an output section that performs an output processing to retrieve the number information from the storage section based on the result of the speech recognition processing and notifies the user of the parked position information. The camera may preferably photograph a plurality of images with different periods of exposure time, and the first image may be generated by compositing the plurality of images.

The parking lot system in accordance with the present embodiment may preferably further include a display section, and the output processing may be a processing to display the parked position information at the display section.

The parking lot may preferably have a plurality of divided blocks where the vehicle can be parked, the parked position information may preferably indicate one of the divided blocks where the vehicle is parked, and the camera may be installed at each of the divided blocks.

The parking lot system in accordance with the present embodiment may have a sensor that detects a vehicle parked at each of the divided blocks, and the camera may generate the first image when the sensor detects that the vehicle is parked. The sensor may be arranged in the same housing as the camera, or may be arranged at a position remote from the camera. Although not particularly illustrated, if a car stop is provided in a divided block, the sensor may be arranged in the car stop, or in the divided block. Moreover, as long as parking of the vehicle can be detected, the sensor may be an optical sensor, or a sensor that detects the weight or the pressure.

The parking lot system according to the present embodiment may preferably further include a judgment section, the storage section may preferably store predetermined registration number information, and the judgment section may preferably compare the predetermined registration number information with the number information. The predetermined registration numbers may be downloaded through a network and stored in the storage section 30. As a result, even in a place located remote from the parking lot system, it becomes easy to store registration numbers in the storage section. Though not illustrated, registration numbers to be stored in the storage section may be inputted from an operation panel installed at the parking lot system, or through an SD memory card, etc., or through the speech acquisition section and the speech recognition section.

When the number information corresponds to the predetermined registration number information, the judgment section may make a notification through a network. As a result, the presence of the vehicle with the predetermined registration number can be acknowledged from a location remote from the parking lot. Moreover, the gate may be controlled to restrict the vehicle with the predetermined registration number such that the vehicle cannot exit the block or the parking lot where the vehicle is parked.

Also, when the speech recognition processing judges that the voice corresponds to the predetermined registration number, a signal of the voice may be stored in the storage section. By this, voice information of the person who is assumed to be related to the predetermined registration number can be acquired.

Note that the embodiments and the embodiment examples described above are only examples, and do not limit the invention. For example, each of the embodiments and the modification examples may be combined with others.

The invention is not limited to the embodiments and concrete examples described above, and many modifications can be made. For example, the invention may include compositions that are substantially the same as the compositions described in the embodiments (for example, a composition with the same function, method and result, or a composition with the same objects and result). Also, the invention includes compositions in which portions not essential in the compositions described in the embodiments are replaced with others. Also, the invention includes compositions that achieve the same functions and effects or achieve the same objects of those of the compositions described in the embodiments. Furthermore, the invention includes compositions that include publicly known technology added to the compositions described in the embodiments. The invention is widely applicable within the range that does not depart from the subject matter of the invention.

What is claimed is:

1. A parking lot system in a system for managing a parking lot, comprising:
a camera that photographs an image including a number plate of a vehicle, and generates a first image;
an image analysis section that performs a number analysis processing to analyze the first image and acquire number information described on the number plate of the vehicle;
a storage section that stores the number information and parked position information of the vehicle associated with one another;
a speech acquisition section to acquire the voice of the user;
a speech recognition section that performs a speech recognition processing on the voice; and
an output section that performs an output processing to retrieve the number information from the storage section based on the result of the speech recognition processing and notifies the user of the parked position information.

2. The parking lot system according to claim 1, wherein the camera photographs a plurality of the images with different periods of exposure time, and the first image is generated by compositing the plurality of the images.

3. The parking lot system according to claim 2, wherein the parking lot has a plurality of divided blocks where the vehicle can be parked, the parked position information indicates one of the divided blocks where the vehicle is parked, and the camera is installed at each of the divided blocks.

4. The parking lot system according to claim 3, further comprising a sensor at each of the divided blocks, for detecting parking of the vehicle, the camera generating the first image upon detection by the sensor of parking of the vehicle.

5. The parking lot system according to claim 4, further comprising a judgment section, the storage section storing predetermined registration number information, and the judgment section comparing the predetermined number information with the number information.

6. The parking lot system according to claim 5, wherein the predetermined register number is stored in the storage section through a network.

7. The parking lot system according to claim 6, wherein the judgment section communicates through the network when the number information coincides with the predetermined registration number.

8. The parking lot system according to claim 7, wherein a signal of the voice is stored in the storage section, when the speech recognition processing judges that the voice coincides with the predetermined registration number.

9. The parking lot system according to claim 8, further comprising a display section, the output processing being a processing to display the parked position information at the display section.
